(19) United States
(12) Patent Application Publication
(10) Pub. No.: US 2026/0131685 A1
(43) Pub. Date: May 14, 2026

(54) SOLAR CHARGING SYSTEM

(71) Applicant: TOYOTA JIDOSHA KABUSHIKI KAISHA, Toyota-shi (JP)

(72) Inventors: Tomohiro NAREMATSU, Nisshin-shi (JP); Takaya KOSHII, Nagoya-shi (JP); Yuma MIYAMOTO, Miyoshi-shi (JP); Yukinori MURAKAMI, Toyota-shi (JP); Akihiro KAWAMURA, Okazaki-shi (JP)

(73) Assignee: TOYOTA JIDOSHA KABUSHIKI KAISHA, Toyota-shi (JP)

(21) Appl. No.: 19/366,271

(22) Filed: Oct. 22, 2025

(30) Foreign Application Priority Data
Nov. 13, 2024 (JP) 2024-198301

(51) Int. Cl. B60L 53/62; B60L 53/51; B60R 16/033; H02J 7/35; H02S 20/30

(52) U.S. Cl. CPC B60L 53/62; B60L 53/51; B60R 16/033; H02J 7/35; H02S 20/30

(57) ABSTRACT

A solar charging system configured to be mounted on a vehicle includes: a solar panel; an auxiliary battery and a drive battery each configured to be charged using electric power generated by the solar panel; and a control unit configured to control a destination to be supplied with the electric power generated by the solar panel based on a result of a comparison of the generated electric power with a first threshold and the amount of electric power stored in the auxiliary battery. The control unit is configured to set the first threshold based on the charging electric current and the charging speed of the auxiliary battery.

### CROSS-REFERENCE TO RELATED APPLICATION

This application claims priority to Japanese Patent Application No. 2024-198301 filed on Nov. 13, 2024. The disclosure of the above-identified application, including the specification, drawings, and claims, is incorporated by reference herein in its entirety.

### BACKGROUND

### 1. Technical Field

The present disclosure relates to a solar charging system.

### 2. Description of Related Art

Japanese Unexamined Patent Application Publication No. 2024-047238 (JP 2024-047238 A) discloses a solar charging system that controls the supply of electric power generated by a solar panel mounted on a vehicle. In a case where the electric power generated by the solar panel is greater than or equal to a predetermined value and the amount of electric power stored in an auxiliary battery is also greater than or equal to a predetermined value, the solar charging system transfers electric power from the solar panel and the auxiliary battery to a drive battery. This increases charging efficiency by solar power generation.

### SUMMARY

The solar charging system described in JP 2024-047238 A does not take into consideration charging electric current, charging speed, or the like for charging the auxiliary battery. The deterioration of the auxiliary battery therefore advances in some cases, resulting in lower usability. There is room for further consideration about a technique that executes efficient charging control while restraining the deterioration from advancing.

The present disclosure provides a solar charging system that makes it possible to restrain the deterioration from advancing and execute efficient charging control.

An aspect of the present disclosure is a solar charging system configured to be mounted on a vehicle. The solar charging system includes: a solar panel; an auxiliary battery and a drive battery each configured to be charged using electric power generated by the solar panel; and a control unit configured to control a destination to be supplied with the electric power generated by the solar panel based on a result of a comparison of the generated electric power with a first threshold and the amount of electric power stored in the auxiliary battery. The control unit is configured to set the first threshold based on the charging electric current and the charging speed of the auxiliary battery.

The control unit may be configured to supply all the generated electric power to the auxiliary battery in a case where the generated electric power is less than the first threshold and the amount of stored electric power is less than a second threshold. The second threshold is set based on electric current to be consumed by a load while the vehicle is parked.

The control unit may be configured to supply all the generated electric power to the auxiliary battery with an electric current limit in a case where the generated electric power is greater than or equal to the first threshold and less than a third threshold and the amount of stored electric power is less than a second threshold. The third threshold is set based on the charging efficiency of the drive battery. The second threshold is set based on electric current to be consumed by a load while the vehicle is parked.

The control unit may be configured to supply all the generated electric power to the drive battery in a case where the generated electric power is greater than or equal to a third threshold and the amount of stored electric power is greater than or equal to the second threshold. The third threshold is set based on the charging efficiency of the drive battery. The second threshold is set based on electric current to be consumed by a load while the vehicle is parked.

The control unit may be configured to supply the generated electric power to the drive battery and the auxiliary battery in a case where the generated electric power is greater than or equal to a third threshold and the amount of stored electric power is less than a second threshold. The third threshold is set based on the charging efficiency of the drive battery. The second threshold is set based on electric current to be consumed by a load while the vehicle is parked.

The control unit may be configured to stop the output of the generated electric power in a case where the generated electric power is less than a third threshold and the amount of stored electric power is greater than or equal to a second threshold. The third threshold is set based on the charging efficiency of the drive battery. The second threshold is set based on electric current to be consumed by a load while the vehicle is parked.

The solar charging system according to the present disclosure controls a destination to be supplied with the electric power generated by the solar panel depending on the electric power at the first threshold based on the charging electric current and the charging speed of the auxiliary battery and the amount of electric power stored in the auxiliary battery. This makes it possible to execute efficient charging control with the deterioration of the auxiliary battery restrained from advancing in consideration of the charging electric current, the charging speed, and the like of the auxiliary battery.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram of a solar charging system according to an embodiment of the present disclosure and a peripheral portion thereof;

FIG. 2 is a processing flowchart of solar charging control that is executed by the solar charging system;

FIG. 3 is a diagram illustrating an example of a boost efficiency characteristic of a DCDC converter;

FIG. 4 is a diagram describing a charging path in a state A1;

FIG. 5 is a diagram describing a charging path in a state A2;

FIG. 6 is a diagram describing a charging path in a state B2;

FIG. 7 is a diagram describing a charging path in a state C2; and

FIG. 8 is a diagram illustrating a list of respective states in the solar charging control.

### DETAILED DESCRIPTION OF EMBODIMENTS

A solar charging system according to the present disclosure controls the charge level of a drive battery and the charge level of an auxiliary battery depending on electric power generated by a solar panel and the amount of electric power stored in the auxiliary battery. The control over the charge levels is executed through the control over electric power output from a solar power generating module and electric power converted and output by a DCDC converter from a primary side to a secondary side.

Hereinafter, an embodiment of the present disclosure will be described in detail with reference to the drawings.

### Embodiment

### Configuration

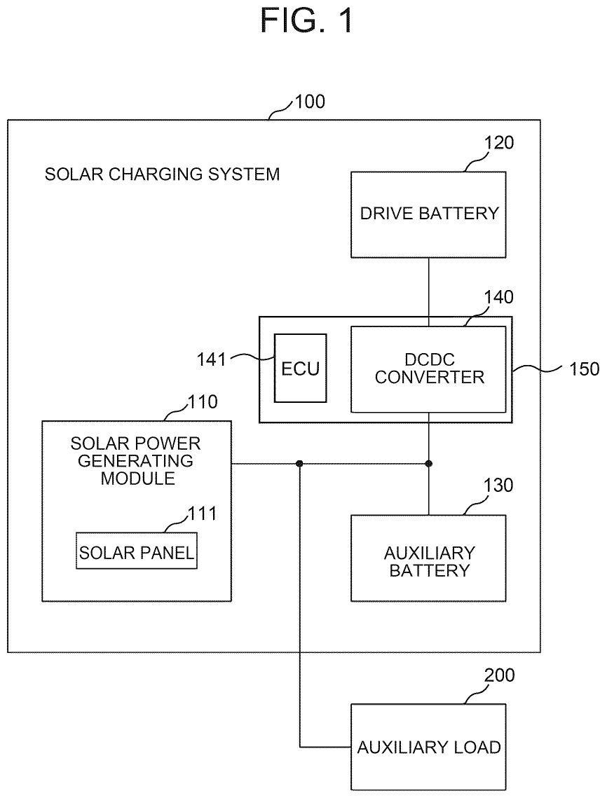

FIG. 1 is a block diagram illustrating schematic configurations of a solar charging system 100 according to an embodiment of the present disclosure and a peripheral portion thereof. The solar charging system 100 exemplified in FIG. 1 includes a solar power generating module 110, a drive battery 120, an auxiliary battery 130, and a DCDC converter 140. The solar charging system 100 is mounted, for example, on a vehicle, such as a hybrid electric vehicle (HEV), a plug-in HEV (PHEV), and a battery electric vehicle (BEV).

The solar power generating module 110 is an electric power generator that generates electric power when irradiated with sunlight. The solar power generating module 110 outputs the generated electric power to the auxiliary battery 130, an auxiliary load 200, and the like connected to the solar power generating module 110. The solar power generating module 110 includes a solar panel 111 that is an array of solar battery cells. The solar power generating module 110 outputs electric power generated by the solar panel 111 through maximum power point tracker (MPPT) control or the like at a predetermined voltage. The electric power generated by the solar panel 111 is calculated from a value measured by an unillustrated sensor or the like.

The drive battery 120 is a secondary battery, such as a lithium-ion battery, configured to be chargeable and dischargeable. The drive battery 120 is connected to a main device (not illustrated) used to drive a vehicle. The drive battery 120 is capable of supplying electric power necessary to bring the main device into operation. Examples of the main device include a traction electric motor. The drive battery 120 is connected to the solar power generating module 110 through the DCDC converter 140 such that the drive battery 120 is chargeable with electric power generated by the solar panel 111. The drive battery 120 is a high-voltage battery having a higher rated voltage than the rated voltage of the auxiliary battery 130.

The auxiliary battery 130 is a secondary battery, such as a lithium-ion battery, configured to be chargeable and dischargeable. The auxiliary battery (auxiliary LiB) 130 is capable of supplying the auxiliary load 200 with electric power necessary to bring the auxiliary load 200 into operation. The auxiliary battery 130 is connected to the solar power generating module 110 such that the auxiliary battery 130 is chargeable with electric power generated by the solar panel 111. The auxiliary battery 130 is connected to the DCDC converter 140 such that the auxiliary battery 130 is chargeable with electric power stored in the drive battery 120. The amount of electric power stored in the auxiliary battery 130 is monitored by an unillustrated sensor or the like. A small-capacity battery that is less than a normal battery in size, cost, and weight may be used as the auxiliary battery 130.

The DCDC converter 140 is an electric power converting device capable of converting input electric power into electric power having a predetermined voltage and outputting the converted electric power. The primary side of the DCDC converter 140 is connected to the solar power generating module 110, the auxiliary battery 130, and the auxiliary load 200 and the secondary side of the DCDC converter 140 is connected to the drive battery 120. The DCDC converter 140 is capable of supplying electric power output by the solar power generating module 110 connected to the primary side to the drive battery 120 connected to the secondary side. The DCDC converter 140 is also capable of supplying electric power of the drive battery 120 connected to the secondary side to the auxiliary battery 130 and the auxiliary load 200 connected to the primary side. It is thus possible for the DCDC converter 140 to function as a so-called bidirectional DCDC converter that steps up the input voltage of the primary side and uses the input voltage as the output voltage of the secondary side (at the time of a boost operation), and steps down the input voltage of the secondary side and uses the input voltage as the output voltage of the primary side (at the time of a buck operation).

The DCDC converter 140 described above is included in a control unit 150 that controls the transfer of electric power between the drive battery 120 and the auxiliary battery 130 along with an electronic control unit (ECU) 141 or the like that controls the boost and buck operations. The control unit 150 is capable of obtaining electric power (solar-generated electric power) generated by the solar panel 111 of the solar power generating module 110, the amount of electric power stored in the auxiliary battery 130, and the like from the respective sensors.

The control unit 150 controls a destination to be supplied with electric power generated by the solar panel 111. For example, the control unit 150 includes the ECU 141 and the DCDC converter 140.

The ECU 141 includes a processor, a memory, and the like. The ECU 141 compares the electric power generated by the solar panel 111 with a first threshold or a third threshold. The ECU 141 compares the amount of electric power stored in the auxiliary battery 130 with a second threshold. The ECU 141 determines a destination to be supplied with the generated electric power based on results of the comparisons. The first threshold, the second threshold, and the third threshold are preserved in the memory and the ECU 141 is capable of reading the respective thresholds from the memory. The ECU 141 is capable of controlling a boost operation or a buck operation of the DCDC converter 140 and supplying the electric power generated by the solar panel 111 to the auxiliary battery 130 or the drive battery 120 from the solar panel 111.

The auxiliary load 200 is any of various auxiliary devices mounted on the vehicle. The auxiliary load 200 comes into operation when being supplied with generated electric power output from the solar power generating module 110 or electric power stored in the auxiliary battery 130. Examples of the auxiliary devices include a lighting device, such as a headlamp or an interior light, an air conditioner, such as a heater or a cooler, and an autonomous driving or advanced drive assist system.

### Control

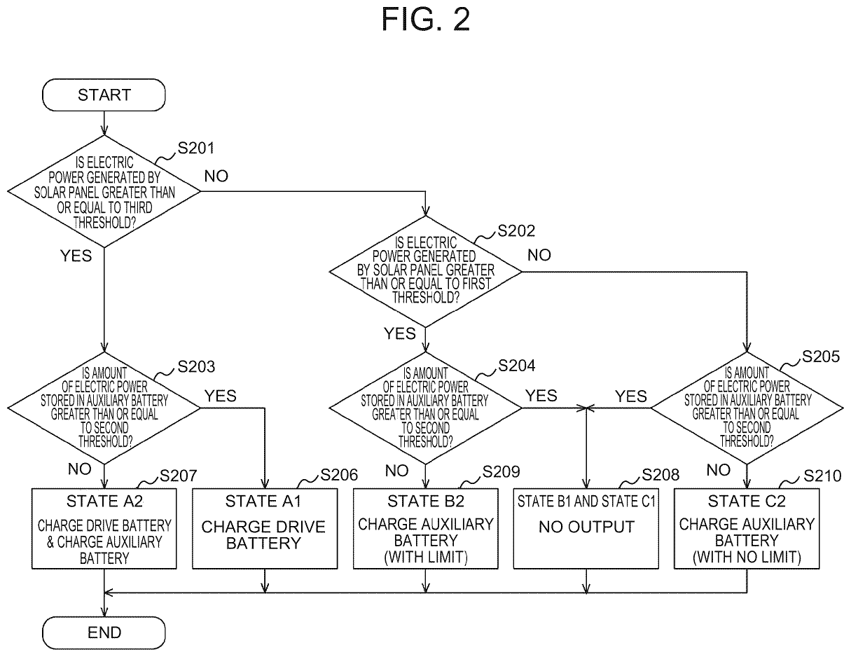

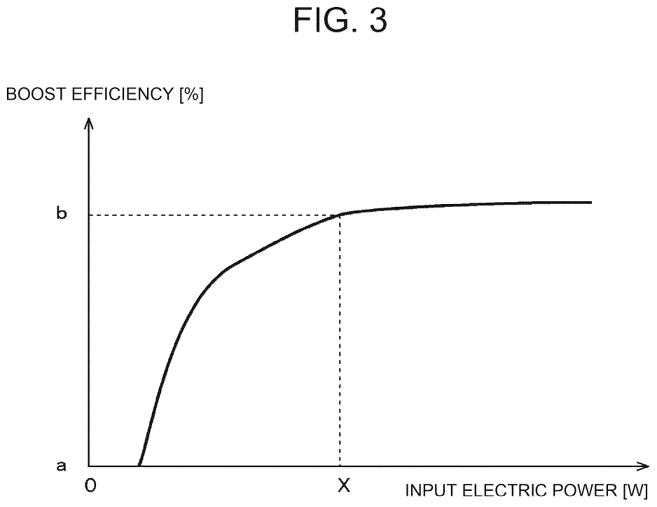

Control executed by the solar charging system 100 according to the present embodiment of the present disclosure will be described with reference to FIGS. 2 and 3. FIG. 2 is a flowchart describing a processing procedure of solar charging control that is executed by the solar charging system 100. FIG. 3 is a diagram illustrating an example of the boost efficiency characteristics of the DCDC converter 140.

The solar charging control exemplified in FIG. 2 is started, for example, in a case where electric power generated by the solar panel 111 of the solar power generating module 110 is greater than electric power that is consumed by ECUs and the like that are necessary to execute the solar charging control.

### Step S201

In the solar charging system 100, the control unit 150 determines whether or not the electric power generated by the solar panel 111 of the solar power generating module 110 is greater than or equal to the third threshold. The determination is made to confirm whether or not it is possible to efficiently charge the drive battery 120 with solar power. Electric power for securing boost efficiency (charging efficiency) that achieves high efficiency is thus set as the third threshold in consideration of the boost efficiency characteristics of the DCDC converter 140. For example, in a case where the DCDC converter 140 has the boost efficiency characteristics that the DCDC converter 140 has higher boost efficiency as the DCDC converter 140 has a higher input voltage from the primary side, it is possible to set electric power corresponding to the boost efficiency to be secured as the third threshold. In the example of FIG. 3, a predetermined value greater than or equal to electric power X at which the boost efficiency achieves high efficiency b or more may be set as the third threshold. For example, the ECU 141 is capable of setting any of values greater than or equal to the electric power X as the third threshold by preserving the value in the memory as the third threshold.

In a case where the control unit 150 determines that the electric power generated by the solar panel 111 is greater than or equal to the third threshold (Yes in step S201), the processing advances to step S203. In a case where the control unit 150 determines that the electric power generated by the solar panel 111 is less than the third threshold (No in step S201), the processing advances to step S202.

### Step S202

The control unit 150 determines whether or not the electric power generated by the solar panel 111 of the solar power generating module 110 is greater than or equal to the first threshold. The determination is made to confirm whether or not it is possible to charge the auxiliary battery 130 with solar power in a case where it is not possible to secure the DCDC converter 140 a highly efficient operation. An electric power value based on a limit value of charging electric current at which the influence on the deterioration of the auxiliary battery 130 grows smaller is thus set as the first threshold. For example, a lithium-ion battery deteriorates more and has lower battery capacity as the number of charging and discharging cycles increases. It is therefore desirable to set an electric power value that allows the number of charging and discharging cycles to be reduced in consideration of the balance between limited charging electric current to the auxiliary battery 130 and charging speed to be secured. It is to be noted that the first threshold is a value smaller than the third threshold described above. For example, the ECU 141 is capable of setting the first threshold by preserving an electric power value based on the limited charging electric current to the auxiliary battery 130 and charging speed to be secured in the memory as the first threshold.

In a case where the control unit 150 determines that the electric power generated by the solar panel 111 is greater than or equal to the first threshold (Yes in step S202), the processing advances to step S204. In a case where the control unit 150 determines that the electric power generated by the solar panel 111 is less than the first threshold (No in step S202), the processing advances to step S205.

### Step S203

The control unit 150 determines whether or not the amount of electric power stored in the auxiliary battery 130 is greater than or equal to the second threshold. The determination is made to determine whether or not the auxiliary battery 130 stores electric power enough to eliminate the necessity of charging. The second threshold is set based on whether or not it is possible to provide idling current (dark current) to be consumed by the auxiliary load 200 while the vehicle is parked from the auxiliary battery 130 alone. More specifically, the amount of stored electric power obtained by adding electric power corresponding to the total amount of idling current to be consumed by the auxiliary load 200 in an expected parking period to the minimum electric power to be secured to start the vehicle is set as the second threshold. For example, the ECU 141 is capable of setting the second threshold by preserving an electric power value necessary to start the vehicle in the memory as the second threshold.

In a case where the control unit 150 determines that the amount of electric power stored in the auxiliary battery 130 is greater than or equal to the second threshold (Yes in step S203), the processing advances to step S206. In a case where the control unit 150 determines that the amount of electric power stored in the auxiliary battery 130 is less than the second threshold (No in step S203), the processing advances to step S207.

### Step S204

The control unit 150 determines whether or not the amount of electric power stored in the auxiliary battery 130 is greater than or equal to the second threshold. The determination and the second threshold are similar to the contents described in step S203.

In a case where the control unit 150 determines that the amount of electric power stored in the auxiliary battery 130 is greater than or equal to the second threshold (Yes in step S204), the processing advances to step S208. In a case where the control unit 150 determines that the amount of electric power stored in the auxiliary battery 130 is less than the second threshold (No in step S204), the processing advances to step S209.

### Step S205

The control unit 150 determines whether or not the amount of electric power stored in the auxiliary battery 130 is greater than or equal to the second threshold. The determination and the second threshold are similar to the contents described in step S203.

In a case where the control unit 150 determines that the amount of electric power stored in the auxiliary battery 130 is greater than or equal to the second threshold (Yes in step S205), the processing advances to step S208. In a case where the control unit 150 determines that the amount of electric power stored in the auxiliary battery 130 is less than the second threshold (No in step S205), the processing advances to step S210.

### Step S206

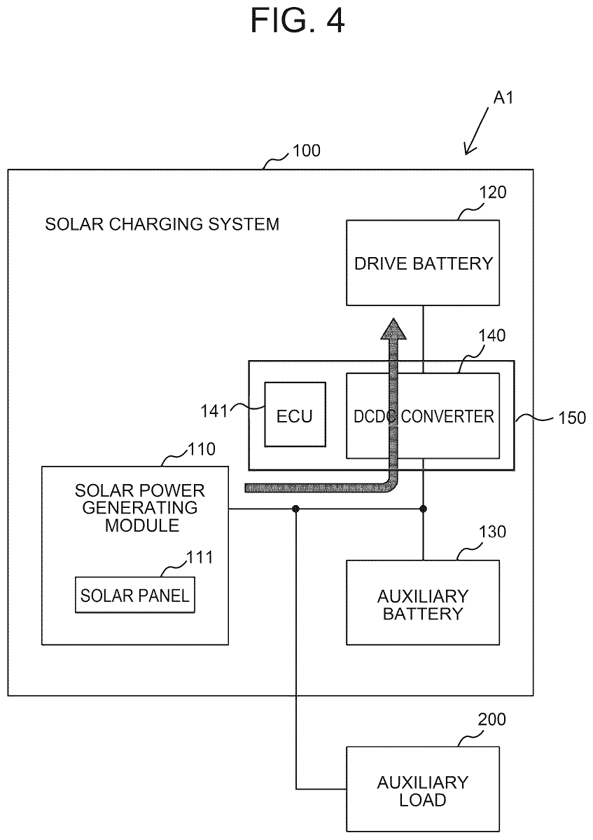

The control unit 150 executes charging control (state A1) of outputting electric power generated by the solar panel 111 to only the drive battery 120. FIG. 4 illustrates the state A1 in which electric power generated by the solar panel 111 is output to only the drive battery 120 through charging control. The arrow in FIG. 4 represents a charging path in the state A1. As illustrated in FIG. 4, all the electric power generated by the solar panel 111 is used to charge the drive battery 120 through the control of the DCDC converter 140 in the state A1.

When the charging control in the state A1 is executed by the control unit 150, the present solar charging control comes to an end.

### Step S207

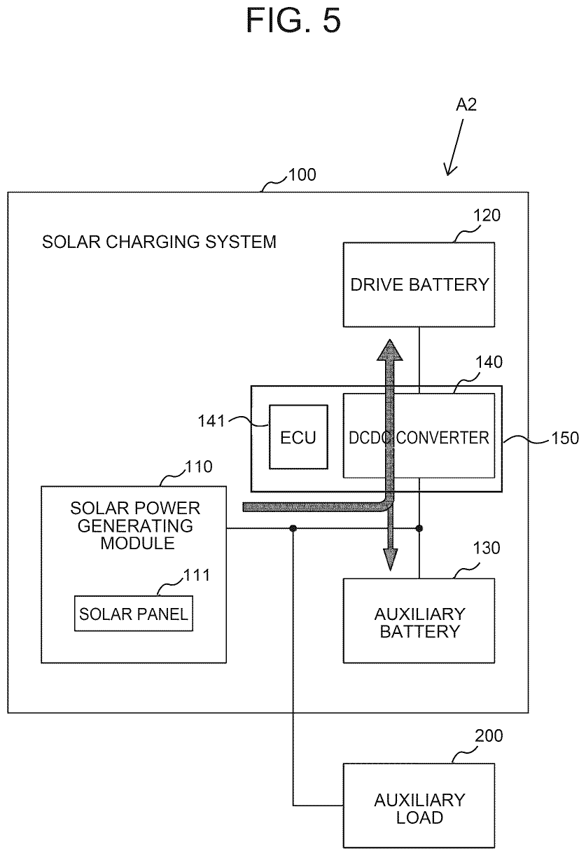

The control unit 150 executes charging control of dividing electric power generated by the solar panel 111 and outputting the divided electric power to the drive battery 120 and the auxiliary battery 130. FIG. 5 illustrates a state A2 in which electric power generated by the solar panel 111 is divided and output to the drive battery 120 and the auxiliary battery 130 through charging control. The arrow in FIG. 5 represents a charging path in the state A2. As illustrated in FIG. 5, a portion of the electric power generated by the solar panel 111 corresponding to the third threshold is used to charge the drive battery 120 and the surplus electric power is used to charge the auxiliary battery 130 in the state A2.

When the charging control in the state A2 is executed by the control unit 150, the present solar charging control comes to an end.

### Step S208

Since the control unit 150 is capable of charging neither the drive battery 120 nor the auxiliary battery 130, the solar power generating module 110 does not output electric power generated by the solar panel 111. In other words, the control unit 150 executes control to cause the solar panel 111 to enter a state B1 and a state C1 in which the output of the generated electric power is stopped.

When the charging control in the state B1 and the state C1 is executed by the control unit 150, the present solar charging control comes to an end.

### Step S209

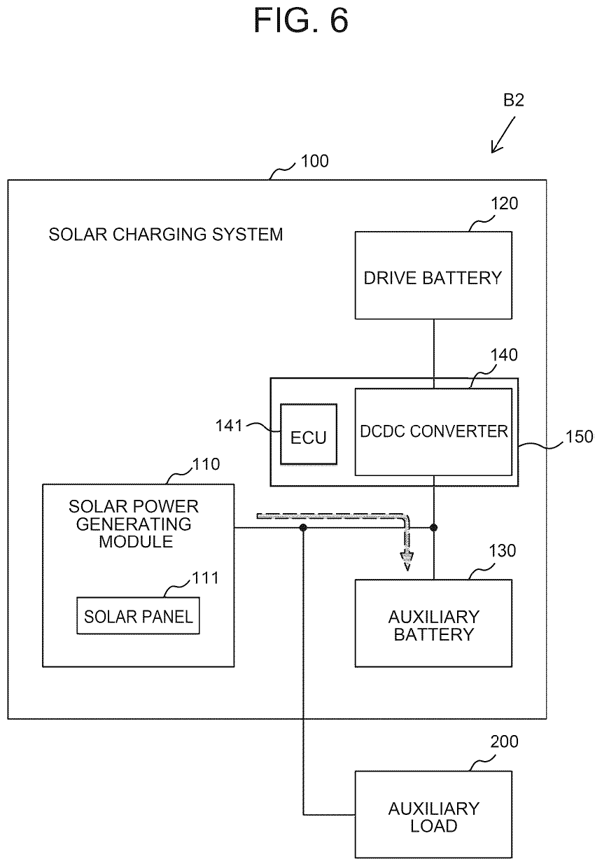

The control unit 150 executes charging control of outputting electric power generated by the solar panel 111 to only the auxiliary battery 130 with an electric current limit. FIG. 6 illustrates a state B2 in which electric power generated by the solar panel 111 is output to only the auxiliary battery 130 with an electric current limit through charging control. The arrow in FIG. 6 represents a charging path in the state B2. As illustrated in FIG. 6, electric power output by the solar power generating module 110 is controlled such that the charging electric current to the auxiliary battery 130 does not exceed a limit value, and all the electric power generated by the solar panel 111 is used to charge the auxiliary battery 130 in the state B2.

When the charging control in the state B2 is executed by the control unit 150, the present solar charging control comes to an end.

### S210

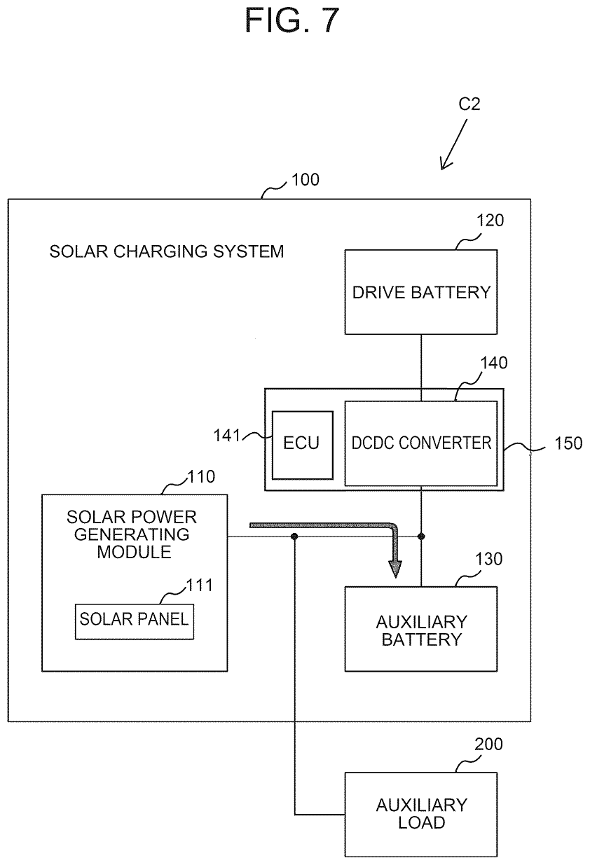

The control unit 150 executes charging control of outputting electric power generated by the solar panel 111 to only the auxiliary battery 130 with no electric current limit. FIG. 7 illustrates a state C2 in which electric power generated by the solar panel 111 is output to only the auxiliary battery 130 with no electric current limit through charging control. The arrow in FIG. 7 represents a charging path in the state C2. As illustrated in FIG. 7, the charging electric current to the auxiliary battery 130 is not limited and all the electric power generated by the solar panel 111 is used to charge the auxiliary battery 130 in the state C2.

When the charging control in the state C2 is executed by the control unit 150, the present solar charging control comes to an end.

It is to be noted that the execution of the charging control in the state in any of steps S206 to S210 brings the solar charging control to an end in the above-described processing flow, but the solar charging control may return to step S201 and be repeatedly executed.

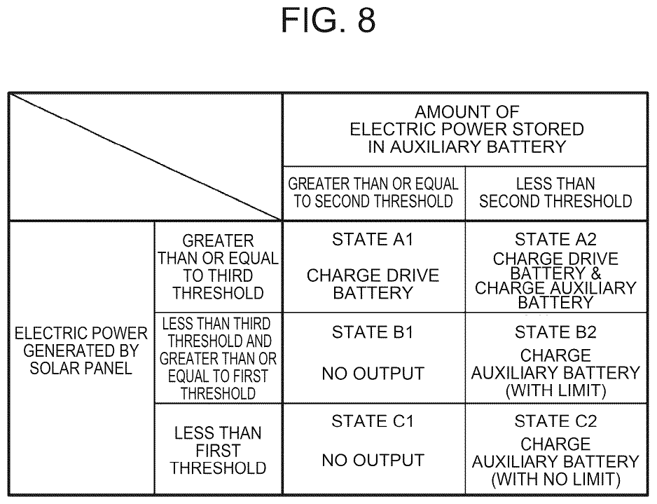

FIG. 8 illustrates a list of the respective states in the solar charging control described above. In the present embodiment, the first threshold and the third threshold are provided as thresholds for a determination about electric power generated by the solar panel 111 and the second threshold is provided as a threshold for a determination about the amount of electric power stored in the auxiliary battery 130 to achieve efficient charging control.

### Workings and Effects

As described above, the control unit 150 of the solar charging system 100 according to an embodiment of the present disclosure dynamically controls a destination to be supplied with electric power generated by the solar panel 111 based on the first threshold set based on the charging electric current and the charging speed of the auxiliary battery 130 for the electric power generated by the solar panel 111 and the second threshold set based on electric current to be consumed by the auxiliary load 200 while the vehicle is parked for the amount of electric power stored in the auxiliary battery 130. The control allows efficient charging control to be executed with the deterioration of the auxiliary battery 130 restrained from advancing.

Although the embodiment of the technology according to the present disclosure has been described, the present disclosure is interpretable as a solar charging control method, a program for the method, and a computer-readable non-transitory storage medium that stores the program, a vehicle including the solar charging system, and the like in addition to the solar charging system.

The solar charging system according to the present disclosure is usable for a vehicle or the like on which a solar panel is mounted.

What is claimed is:

1. A solar charging system configured to be mounted on a vehicle, the solar charging system comprising:
a solar panel;
an auxiliary battery and a drive battery each configured to be charged using electric power generated by the solar panel; and
a control unit configured to control a destination to be supplied with the electric power generated by the solar panel based on a result of a comparison of the generated electric power with a first threshold and an amount of electric power stored in the auxiliary battery, wherein
the control unit is configured to set the first threshold based on charging electric current and charging speed of the auxiliary battery.

2. The solar charging system according to claim 1, wherein the control unit is configured to supply all the generated electric power to the auxiliary battery in a case where the generated electric power is less than the first threshold and the amount of stored electric power is less than a second threshold, the second threshold being set based on electric current to be consumed by a load while the vehicle is parked.

3. The solar charging system according to claim 1, wherein the control unit is configured to supply all the generated electric power to the auxiliary battery with an electric current limit in a case where the generated electric power is greater than or equal to the first threshold and less than a third threshold and the amount of stored electric power is less than a second threshold, the third threshold being set based on charging efficiency of the drive battery, the second threshold being set based on electric current to be consumed by a load while the vehicle is parked.

4. The solar charging system according to claim 1, wherein the control unit is configured to supply all the generated electric power to the drive battery in a case where the generated electric power is greater than or equal to a third threshold and the amount of stored electric power is greater than or equal to the second threshold, the third threshold being set based on charging efficiency of the drive battery, the second threshold being set based on electric current to be consumed by a load while the vehicle is parked.

5. The solar charging system according to claim 1, wherein the control unit is configured to supply the generated electric power to the drive battery and the auxiliary battery in a case where the generated electric power is greater than or equal to a third threshold and the amount of stored electric power is less than a second threshold, the third threshold being set based on charging efficiency of the drive battery, the second threshold being set based on electric current to be consumed by a load while the vehicle is parked.

6. The solar charging system according to claim 1, wherein the control unit is configured to stop an output of the generated electric power in a case where the generated electric power is less than a third threshold and the amount of stored electric power is greater than or equal to a second threshold, the third threshold being set based on charging efficiency of the drive battery, the second threshold being set based on electric current to be consumed by a load while the vehicle is parked.
